(19) United States
(12) Patent Application Publication
(10) Pub. No.: US 2010/0011385 A1
(43) Pub. Date: Jan. 14, 2010

(54) COMPACT DISK FEEDING MECHANISM

(75) Inventors: Ho-Cheng Kang, Taipei County (TW); Tzu-Yun Wang, Taipei County (TW)

Correspondence Address: PAI PATENT & TRADEMARK LAW FIRM, 1001 FOURTH AVENUE, SUITE 3200, SEATTLE, WA, 98154, US

(73) Assignee: BLUHEN TECH ENTERPRISE LTD., Sinjhuang City (TW)

(21) Appl. No.: 12/169,516

(22) Filed: Jul. 8, 2008

(51) Int. Cl. G11B 17/03

(52) U.S. Cl. 720/615

(57) ABSTRACT

A compact disc (CD) feeding mechanism includes a base internally defining a moving passage, and a CD inlet and a CD outlet communicating with an upper and a lower end of the moving passage, respectively, and having a first and a second supporting wall spaced by a shifting path and radially projected into a left side of the CD inlet, an overall length extending along the two supporting walls and the shifting path being larger than one half of the outer circumference of a CD, so that a plurality of CDs may be stacked on the two supporting walls; a driving unit mounted below the base and electrically connected to an external power supply; and a shifting unit including a shifting section driven by the driving unit to shift a lowest one of the stacked CDs out of the supporting walls into the moving passage to the CD outlet.

### FIELD OF THE INVENTION

The present invention relates to a feeding mechanism, and more particularly, to a compact disc feeding mechanism capable of automatically feeding a stack of CDs one by one.

### BACKGROUND OF THE INVENTION

Currently, there are a variety of compact disks available for use, such as standard compact disks (CDs), video compact disks (VCDs), digital versatile disks (DVDs), or even blu-ray disks (BDs). These compact disks have a wide range of applications, such as being used to store multimedia, data, and music. Therefore, these various compact disks have become one of the important data carriers in the modern society.

In the current mass production of various compact disks, blank compact disks are fed using a CD feeding mechanism that controls the operation of a robot, which includes complicated hydraulic linkages, vacuum cup, and many other components. A topmost one of a stack of blank compact disks is sucked by the vacuum cup to achieve the purpose of feeding the blank compact disk. The above-described conventional CD feeding mechanism has relatively poor applicability due to the following disadvantages in the practical use thereof:
(1) The conventional CD feeding mechanism involves in a large number of very complicated components and is therefore not easy to assemble, maintain, or repair. Moreover, the large number of complicated components results in a bulky CD feeding mechanism, which could not be widely applied to general commercial and personal applications; and
(2) A plurality of procedures, such as vacuum sucking, displacing, releasing vacuum sucking, and returning of the robot, are required in the process of feeding the compact disks to consume a lot of time and efforts. Therefore, the conventional CD feeding mechanism is low-efficient in the operation thereof.

### SUMMARY OF THE INVENTION

A primary object of the present invention is to provide a CD feeding mechanism that has simplified components and is easy to assemble and maintain.

Another object of the present invention is to provide a CD feeding mechanism that has a small volume suitable for general commercial or personal applications.

A further object of the present invention is to provide a high-efficient CD feeding mechanism capable of feeding CDs in a time-saving and effortless manner.

To achieve the above and other objects, the CD feeding mechanism according to the present invention includes a base, a driving unit, and a shifting unit.

The base includes a main body, a first supporting wall, and a second supporting wall. The main body internally defines a moving passage, a CD inlet, and a CD outlet. The CD inlet is formed at a top of the main body to communicate with an upper end of the moving passage, and the CD outlet is located at and communicable with a lower end of the moving passage.

The first and second supporting walls of the base are formed in the moving passage and radially projected into a left side of the CD inlet. The first and the second supporting wall are spaced from each other to define a shifting path between them, and the shifting path is communicable with the moving passage. An overall length extending along the first supporting wall, the shifting path, and the second supporting wall is larger than one half of an outer circumference of a CD to be fed, so that a plurality of CDs may be stably stacked and supported on the first and the second supporting wall; and, after deducting the spaces occupied by the first and the second supporting wall, the moving passage has a remaining space just sufficient for the CD to pass therethrough to the CD outlet.

The driving unit is mounted in a lower side of the main body and adapted to electrically connect to an external power supply to obtain required working power.

The shifting unit is slidably mounted in the shifting path and driven by the driving unit to move rightward or leftward in the shifting path. The shifting unit includes a shifting section for shifting a lowest one of the stacked CDs out of the first and the second supporting wall into the moving passage to the CD outlet.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a CD feeding mechanism according to a preferred embodiment of the present invention;

FIG. 2 is still an exploded perspective view of the CD feeding mechanism of FIG. 1 viewed from another angle;

FIG. 3 is a partial top plan view of the CD feeding mechanism of FIG. 1 showing the supporting walls formed on a base of the CD feeding mechanism;

FIG. 4 is a partial bottom perspective view of the CD feeding mechanism of FIG. 1 showing a rib and two sliding channels formed below the base;

FIG. 5 is a top cutaway view of the CD feeding mechanism of FIG. 1 viewed from a rear left side thereof;

FIG. 6 is a bottom view of FIG. 5;

FIG. 7 is a schematic sectioned side view of the CD feeding mechanism of FIG. 1;

FIG. 8 is another schematic sectioned side view of the CD feeding mechanism of FIG. 1 showing a shifting unit of the CD feeding mechanism starts shifting a lowest CD;

FIG. 9 is still another schematic sectioned side view of the CD feeding mechanism of FIG. 1 showing the lowest CD follows a beveled surface of the rib below the base to gradually move downward while all other CDs are pushed upward by a lifting roller;

FIG. 10 is still another schematic sectioned side view of the CD feeding mechanism of FIG. 1 showing the lowest CD is guided by two guiding slopes to a CD outlet of the CD feeding mechanism;

FIG. 11 is a further schematic sectioned side view of the CD feeding mechanism of FIG. 1 showing the shifting unit is returned to a home position and the initially next lowest CD is descended to the lowest position in the CD feeding mechanism;

FIG. 12 is a schematic top plan view showing the CD feeding mechanism of the present invention may have a CD outlet located at a bottom thereof; and

FIG. 13 is a sectioned side view of the CD feeding mechanism of FIG. 12 with the CD outlet located at the bottom thereof.

### DETAILED DESCRIPTION OF THE PREFERRED EMBODIMENTS

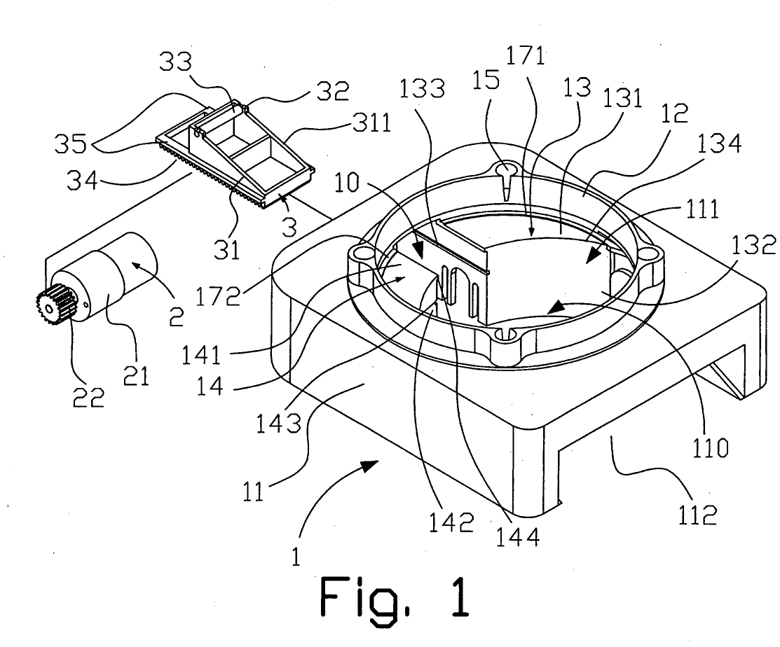

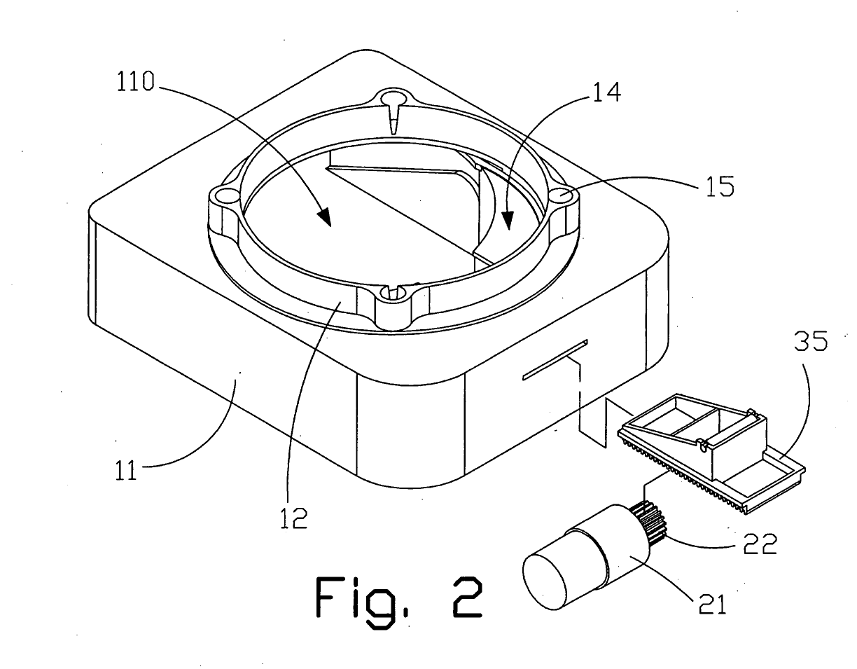

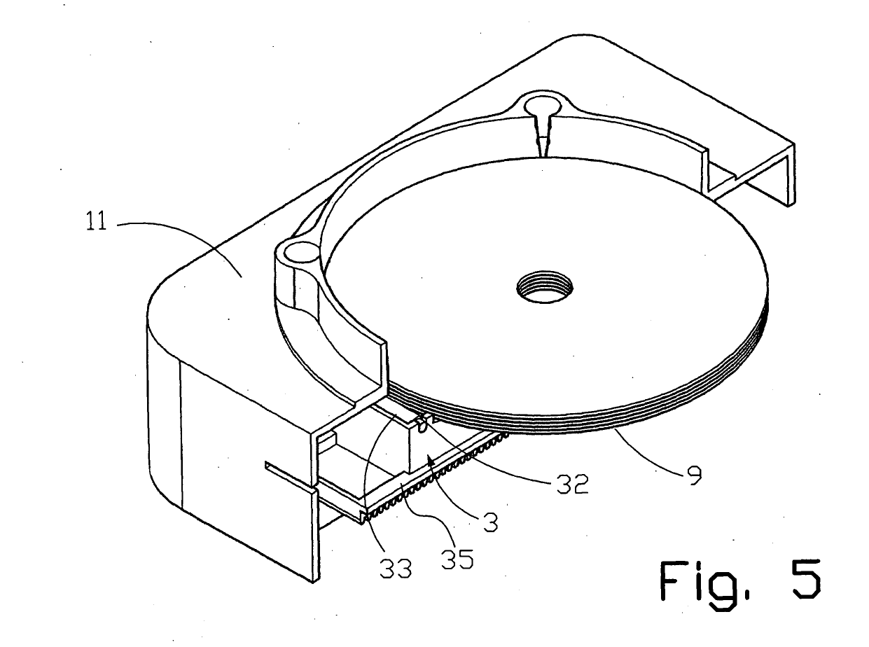

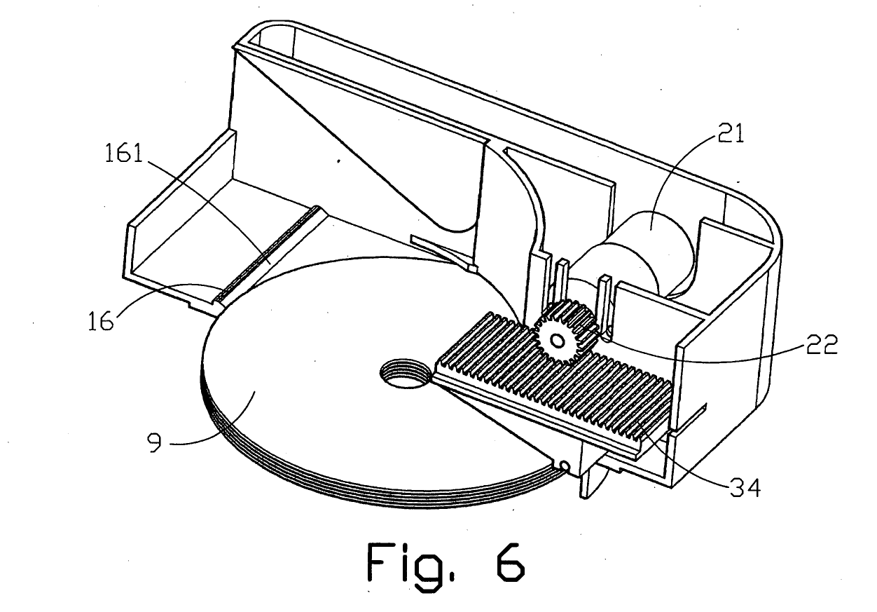

Please refer to FIGS. 1, 2, 5, and 6, in which a CD feeding mechanism according to a preferred embodiment of the present invention is shown. As shown, the CD feeding mechanism of the present invention includes a base 1, a driving unit 2, and a shifting unit 3.

In the following description, the phrases “right side”, “left side”, “front side”, and “rear side” shall correspond to the right, left, front, and rear sides of the base 1, respectively, when viewing the base 1 in front of the illustrated FIG. 1.

The base 1 is configured to carry a plurality of CDs 9 thereon. The base 1 includes a main body 11, an annular wall portion 12, a first supporting wall 171, a second supporting wall 172, a third supporting wall 13, a fourth supporting wall 14, four locating sections 15, and two guiding slopes 18.

The main body 11 is substantially a rectangular hollow body internally defining a moving passage 110, a CD inlet 111, and a CD outlet 112. The CD inlet 111 is located at a top of the main body 11 to vertically communicate with an upper end of the moving passage 110. The CD outlet 112 is located at a right side of the main body 11 to sidewardly communicate with a lower end of the moving passage 110. The CD inlet 111 and the CD outlet 112 are sized to match the size of the CDs 9 to be fed, so as to allow the CDs 9 to move therethrough. The annular wall portion 12 is extended along an outer periphery of the CD inlet 111 to locate on the top of the main body 11, so as to confine the plurality of CDs 9 for them to orderly vertically stack in the annular wall portion 12 and smoothly enter the CD inlet 111 one by one.

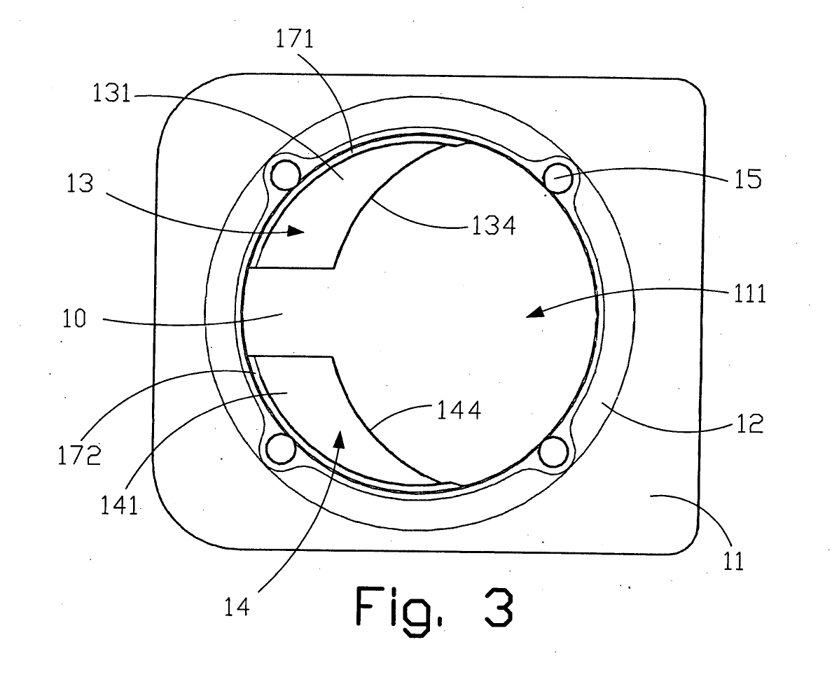

Please refer to FIG. 3. The first supporting wall 171 and the second supporting wall 172 are formed inside the main body 11 to space from each other in a mirror symmetry relation, and are located in the moving passage 110 to correspondingly radially project into the CD inlet 111 from a left side thereof, so as to cooperatively support the stack of CDs 9 on the first and second supporting walls 171, 172. The space between the first and the second supporting wall 171, 172 is hereby defined as a shifting path 10 communicating with the moving passage 110.

What is to be noted is an overall length extending along the first supporting wall 171, the shifting path 10, and the second supporting wall 172 is larger than one half of an outer circumference of the CD 9, so that the CDs 9 may be stably stacked and supported on the first and the second supporting wall 171, 172. Further, in the illustrated preferred embodiment of the present invention, a distance from a top of the first and the second supporting wall 171, 172 to the CD inlet 111 is substantially equal to a thickness (or height) of the CD 9.

The third supporting wall 13 and the fourth supporting wall 14 are also formed inside the main body 11 in a mirror symmetry relation for restricting the CDs 9 to move along the moving passage 110. The third and the fourth supporting wall 13, 14 are spaced from each other by the shifting path 10. Meanwhile, the third and the fourth supporting wall 13, 14 are located below and spaced from the first and the second supporting wall 171, 172, respectively.

Each of the third and the fourth supporting wall 13, 14 includes a horizontal wall portion 131, 141, a vertical wall portion 132, 142, and a sliding channel 133, 143 formed on the vertical wall portion 132, 142 to communicate with the shifting path 10 and horizontally extend from the left side toward the right side of the base 1.

The horizontal wall portions 131, 141 are connected at respective left side to an inner left side of the main body 11, and have a large part being located in the moving passage 110. The vertical wall portions 132, 142 are connected at respective upper edge to the corresponding horizontal wall portions 131, 141, and at respective lateral edges to inner sides of the main body 11, so as to support the horizontal wall portions 131, 141 thereon.

Further, in the illustrated preferred embodiment, for the CDs 9 to sequentially move via the moving passage 110 to the CD outlet 112, the horizontal wall portions 131, 141 respectively have a right side formed into a curved edge 134, 144 corresponding to the shape of the CD 9, and the main body 11 is internally provided at a front side and a rear side corresponding to the moving passage 110 with a guide slope 18 each. The guide slopes 18 are inclined from an upper left side toward a lower right side of the main body 11. After deducting the spaces occupied by the first supporting wall 171, the second supporting wall 172, and the horizontal wall portions 131, 141, the remaining space in the moving passage 110 is just sufficient for the CD 9 to pass through the moving passage 110 to the CD outlet 112.

To allow a user to flexibly increase the number of CDs 9 to be stacked on the main body 11 in the annular wall portion 12, at least three locating sections 15 (four are illustrated in the preferred embodiment) are equally spaced along an outer side of the annular wall portion 12 on the base 1. In the illustrated preferred embodiment, the locating sections 15 are in the form of vertically extended insertion holes. A user may insert additional elements, such as four posts (not shown), in the locating sections 15 for framing more stacked CDs 9 therebetween, so that more CDs 9 may be stored on the CD feeding mechanism of the present invention for use. However, it is understood the locating sections 15 are not limited to the configuration shown in the preferred embodiment of the present invention. Instead, the user may change the form of the locating sections 15 depending on actual need in design, so long as the locating sections 15 may allow the user to store more CDs 9 on the CD feeding mechanism.

The driving unit 2 is fixedly mounted to a lower side in the base 1 and is electrically connected to an external power supply, such as a direct current (DC) power supply, to obtain necessary working power. The driving unit 2 includes an actuator 21 electrically connected to and controlled by the external power supply to rotate clockwise or counterclockwise, and a coupler 22 rotatably connected to and brought by the actuator 21 to pivotally turn about an axis of the coupler 22. In the illustrated preferred embodiment, the actuator 21 is in the form of a DC motor, and the coupler 22 is in the form of a toothed wheel.

The shifting unit 3 is slidably mounted in the shifting path 10 on the base 1 to horizontally move rightward and leftward, and is located above the coupler 22 of the driving unit 2. The shifting unit 3 is driven by the driving unit 2 to shift the lowest one of the stacked CDs 9 for the same to move out of the base 1. The shifting unit 3 includes a guiding body 31, a shifting section 32, a lifting roller 33, a transmission section 34, and two guide rails 35.

The guiding body 31 has a substantially right triangular longitudinal section with an upper guiding surface 311 downward inclined from a left side to a right side thereof. The inclined guiding surface 311 cooperates with the first and the second supporting wall 171, 172 to support the stacked CDs 9 thereon. The shifting section 32 is integrally formed across the highest position of the inclined guiding surface 311 for shifting the lowest CD 9 away from the first and the second supporting wall 171, 172. The lifting roller 33 is a transverse bar rotatably mounted to a top of the shifting section 32 for lifting and rotatably contacting with other CDs 9 above the lowest CD 9 while the shifting section 32 is shifting the lowest CD 9 rightward. With the lifting roller 33, the friction between the lowest CD 9 and the remaining upper CDs 9 in the course of shifting the lowest CD 9 can be avoided. The transmission section 34 is connected to a lower side of the guiding body 31, and may be driven by the coupler 22 to move rightward and leftward. The two guide rails 35 are separately formed along a front and a rear side of the transmission section 34 for engaging with the sliding channels 133, 143 formed on the third and the fourth supporting wall 13, 14, respectively.

To save the material for manufacturing the CD feeding mechanism of the present invention, the guiding body 31, the transmission section 34, and the shifting section 32 are partially hollow in the structure thereof. In addition, the shifting section 32 has a height substantially matching the thickness of one CD 9, and the lifting roller 33 has a height slightly higher than that of the shifting section 32. In the present invention, the lifting roller 33 is made of a soft or plastic material, such as a rubber material, to avoid scratching the CDs 9 while rotatably contacting with the CDs 9, and the transmission section 34 is in the form of a rack.

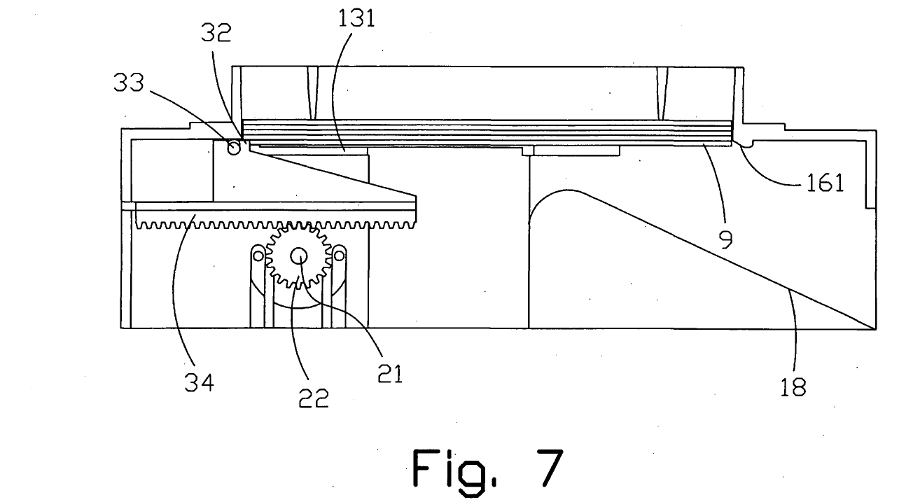

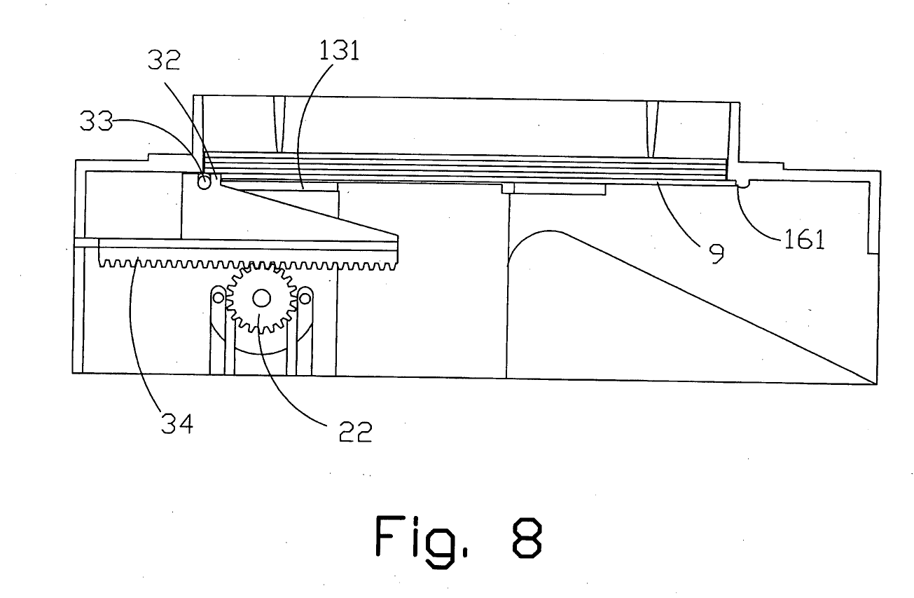

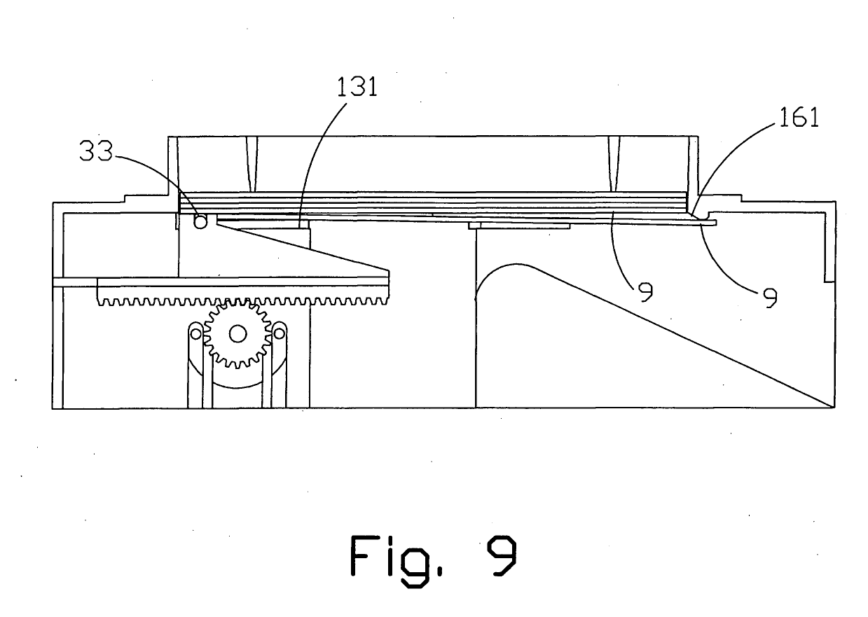

Please refer to FIGS. 7, 8, and 9. When the external power supply is turned on for the CD feeding mechanism of the present invention to start feeding the CDs 9, the actuator 21 of the driving unit 2 is brought to rotate clockwise, so that the coupler 22 is caused to turn about the axis thereof. At this point, the coupler 22 would drive the transmission section 34 and accordingly the whole shifting unit 3 to move rightward along the shifting path 10 and the guide rails 35 to move rightward along the sliding channels 133, 143, bringing the shifting section 32 of the shifting unit 3 to push the lowest CD 9 rightward. Meanwhile, the lifting roller 33, which is slightly higher than the shifting section 32, is also moved into the CD inlet 111 to lift the next lowest CD 9 and all other CDs 9 thereabove.

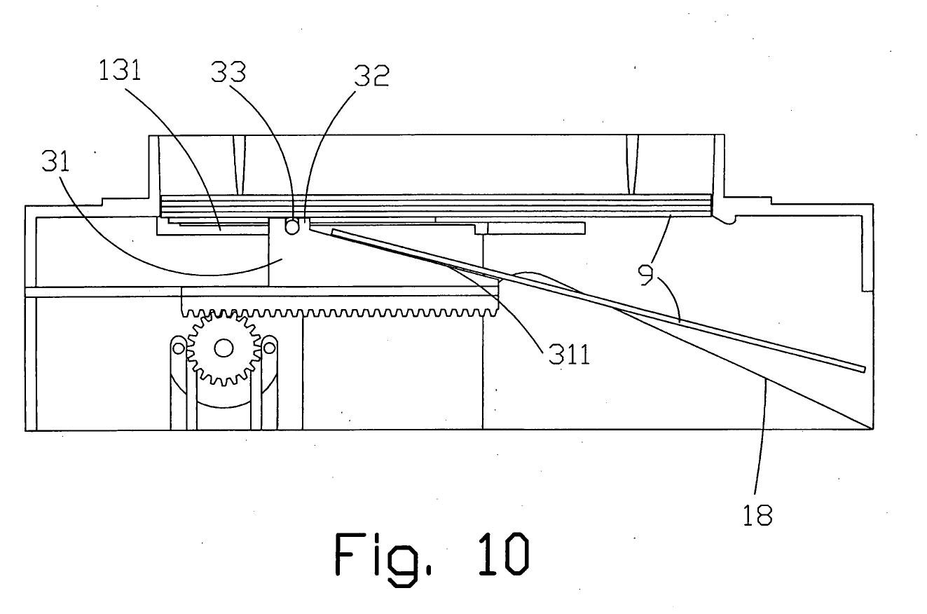

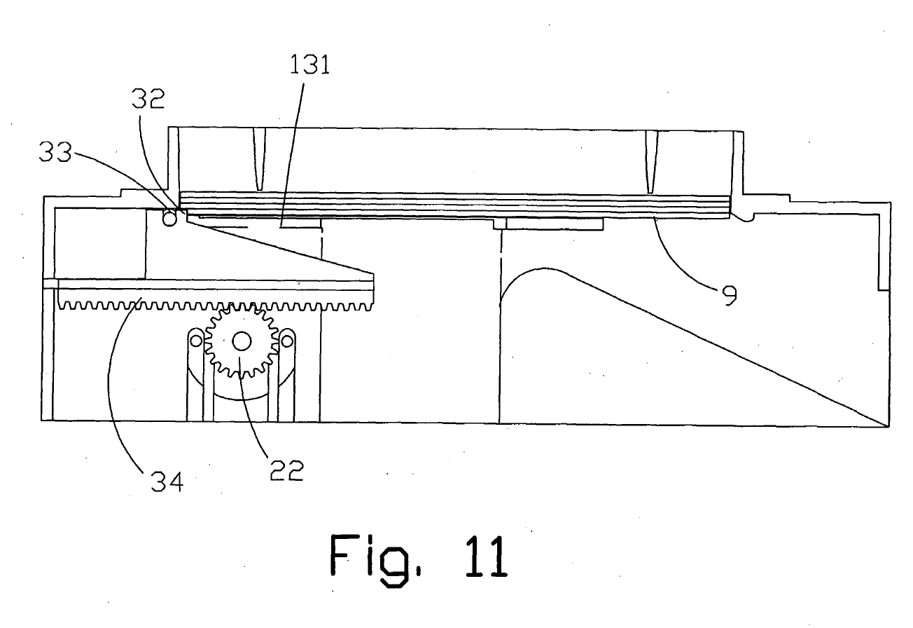

Please refer to FIGS. 10 and 11. When the lowest CD 9 has been completely shifted out of the first, the second, the third, and the fourth supporting wall 171, 172, 13, 14, the CD 9 would follow the inclined guiding surface 311 of the guiding body 31 and the two guide slopes 18 to slide downward through the moving passage 110 to the CD outlet 112. Then, the external power supply is controlled for the coupler 22 of the driving unit 2 to turn counterclockwise, so that the whole shifting unit 3 is brought to shift leftward. When the lifting roller 33 of the shifting unit 3 has been moved to its home position without projecting into the CD inlet 111, the next lowest CD 9 along with all other CDs 9 located thereabove would descend to the top of the first and second supporting walls 171, 172 and the inclined guiding surface 311. The initially next lowest CD 9 is now the lowest CD 9 in the CD feeding mechanism.

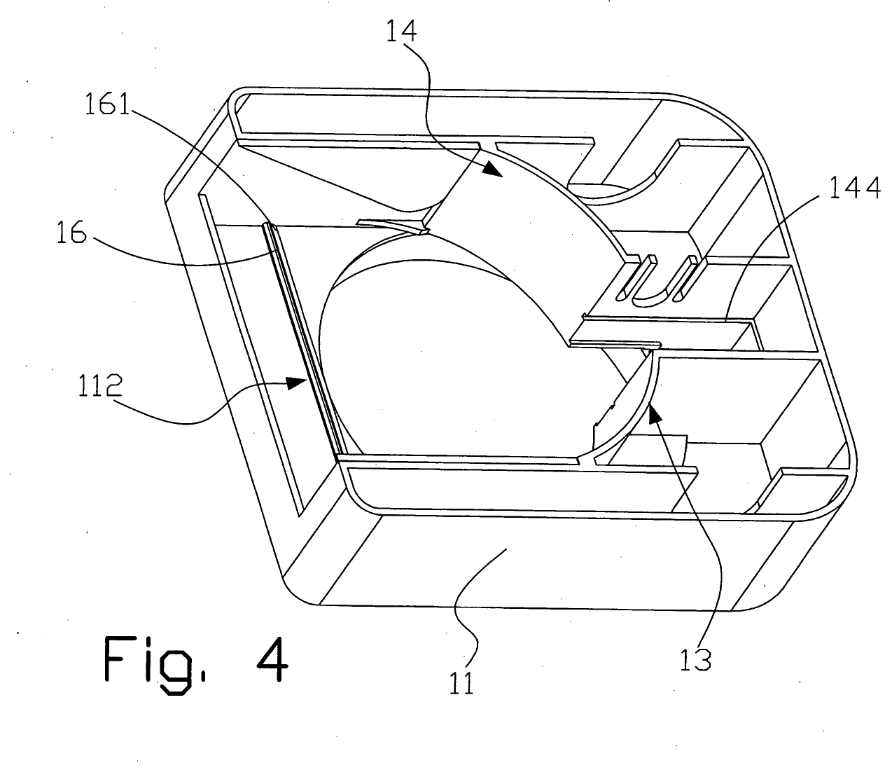

Please refer to FIG. 4. For the CD 9 to move out of the base 1 more quickly, the base 1 is further provided below the CD inlet 111 near the rightmost outer side thereof with a rib 16. As can be clearly seen from FIGS. 4 and 7, one side of the rib 16 closer to the CD inlet 111 is a rightward downward inclined beveled surface 161 for guiding the CD 9 rightward to move downward quickly.

To use the CD feeding mechanism of the present invention, first bridge the CD feeding mechanism with a computer case (not shown) and a CD recorder (not shown). Through control via the computer, the CD feeding mechanism may sequentially feed the CDs 9 to the recorder one by one. Therefore, the CD feeding mechanism of the present invention has good applicability and is flexible in design.

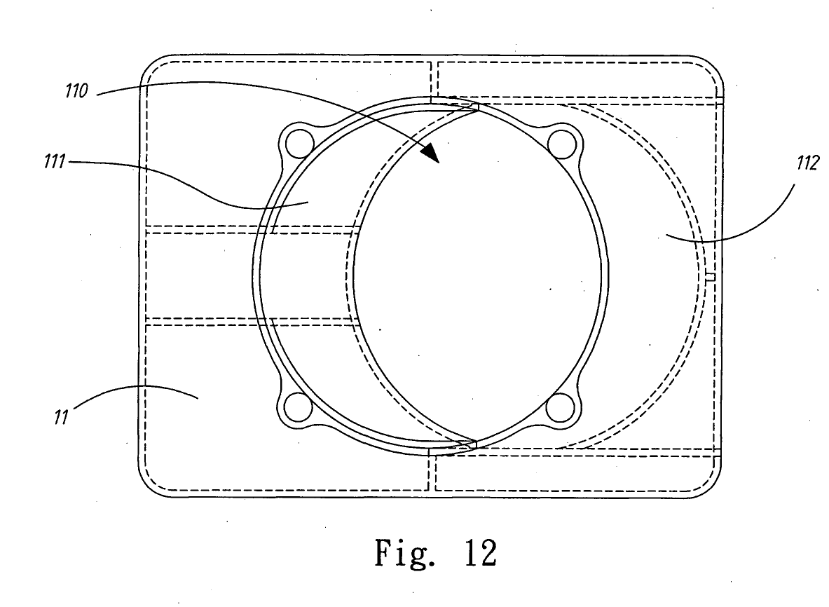

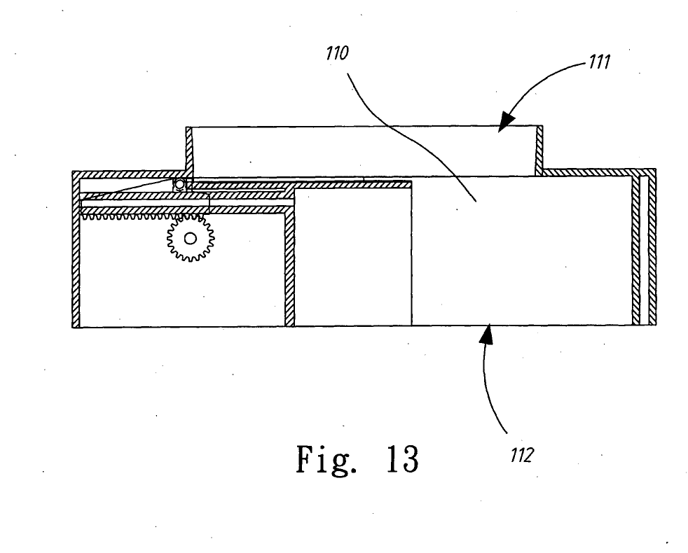

In the preferred embodiment, the CD outlet 112 is located at a lower right side of the main body 11. However, the CD outlet 112 may also be otherwise located at a bottom of the main body 11, as shown in FIGS. 12 and 13, to achieve the same effect. That is, the position of the CD outlet 112 is not particularly restricted, so long as the CD outlet 112 allows the CDs 9 to pass through the moving passage 110 and move out of the base 1.

In the present invention, the CD feeding mechanism constructed from the base, the driving unit, and the shifting unit not only provides the advantages of feeding CDs quickly and accurately to save time and efforts, but also has effectively reduced components and volume to enable convenient assembly and maintenance thereof. In brief, the CD feeding mechanism of the present invention is efficient for use and has good applicability.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A compact disk (CD) feeding mechanism, comprising a base, a driving unit, and a shifting unit:
the base including a main body, a first supporting wall, and a second supporting wall; the main body internally defining a moving passage, a CD inlet, and a CD outlet; the CD inlet being formed at a top of the main body to communicate with an upper end of the moving passage, and the CD outlet being located at and communicable with a lower end of the moving passage;
the first and second supporting walls of the base being formed in the moving passage and radially projected into a left side of the CD inlet; the first and the second supporting wall being spaced from each other to define a shifting path between them, and the shifting path being communicable with the moving passage; wherein an overall length extending along the first supporting wall, the shifting path, and the second supporting wall is larger than one half of an outer circumference of a CD to be fed, so that a plurality of CDs may be stably stacked and supported on the first and the second supporting wall; and wherein, after deducting the spaces occupied by the first and the second supporting wall, the moving passage has a remaining space just sufficient for the CD to pass through the moving passage to the CD outlet;
the driving unit being mounted in a lower side of the main body and adapted to electrically connect to an external power supply to obtain required working power; and
the shifting unit being slidably mounted in the shifting path and driven by the driving unit to move rightward or leftward in the shifting path; and the shifting unit including a shifting section for shifting a lowest one of the stacked CDs out of the first and the second supporting wall.

2. The CD feeding mechanism as claimed in claim 1, wherein the base further includes a third supporting wall and a fourth supporting wall for restricting the CDs to move along the moving passage; the third and the fourth supporting wall being formed inside the main body and spaced from each other by the shifting path; and the third and the fourth supporting wall being located below and spaced from the first and the second supporting wall, respectively.

3. The CD feeding mechanism as claimed in claim 1, wherein the base is further provided inside the main body at a front and a rear side of the moving passage with a guide slope each; and the guide slopes being inclined from an upper left side toward a lower right side of the main body for guiding the CD shifted out of the first and second supporting walls to move toward the CD outlet.

4. The CD feeding mechanism as claimed in claim 1, wherein the shifting unit further includes a guiding surface downward inclined from a left side to a right side thereof, and the inclined guiding surface cooperating with the two supporting walls to support the stacked CDs thereon; and wherein the shifting section being integrally formed across the leftmost side of the inclined guiding surface.

5. The CD feeding mechanism as claimed in claim 1, wherein the base further includes an annular wall portion extended along an outer periphery of the CD inlet to locate on the top of the main body, so as to confine the plurality of CDs for them to orderly vertically stack in the annular wall portion and smoothly enter the CD inlet.

6. The CD feeding mechanism as claimed in claim 5, wherein the base further includes at least three locating sections equally spaced along an outer side of the annular wall portion, so that a user may insert additional elements in the locating sections for framing more CDs therebetween.

7. The CD feeding mechanism as claimed in claim 2, wherein the third and the fourth supporting wall respectively include a horizontal wall portion and a vertical wall portion; the horizontal wall portions being connected at respective left side to the main body and having a large part projected into the left side of the CD inlet; and the vertical wall portions being connected at respective upper edge to the corresponding horizontal wall portions and at respective lateral edges to inner sides of the main body, so as to support the horizontal wall portions thereon.

8. The CD feeding mechanism as claimed in claim 1, wherein a distance from a top of the first and the second supporting wall to the CD inlet is substantially equal to a thickness (or height) of a CD, such that the shifting section is able to shift only the lowest one of the stacked CDs out of the first and the second supporting wall each time.

9. The CD feeding mechanism as claimed in claim 7, wherein the horizontal wall portions of the third and fourth supporting walls each have a right side formed into a curved edge corresponding to a shape of a CD.

10. The CD feeding mechanism as claimed in claim 4, wherein the driving unit includes an actuator and a coupler; the actuator being electrically connected to and controlled by the external power supply to rotate clockwise or counterclockwise, and the coupler being rotatably connected to and driven by the actuator to turn about an axis of the coupler; and wherein the shifting unit further includes a transmission section located below the inclined guiding surface, and the transmission section being engaged with and driven by the coupler of the driving unit to move the whole shifting unit leftward or rightward.

11. The CD feeding mechanism as claimed in claim 10, wherein the coupler is in the form of a toothed wheel, and the transmission section is in the form of a rack.

12. The CD feeding mechanism as claimed in claim 4, wherein the third and the fourth supporting wall respectively have a sliding channel formed thereon to communicate with the shifting path and horizontally extend from the left side toward the right side of the base; and wherein the shifting unit further includes a guiding body, a transmission section, and two guide rails; the guiding body being located in the shifting path with the inclined guiding surface formed on a top thereof; the transmission section being connected to a bottom of the guiding body and driven by the driving unit to move the whole shifting unit leftward or rightward; and the two guide rails being separately formed at two opposite sides of the transmission section for engaging with the sliding channels on the third and fourth supporting walls.

13. The CD feeding mechanism as claimed in claim 1, wherein the shifting unit further includes a lifting roller rotatably mounted to a top of the shifting section; and the lifting roller having a height slightly larger than that of the shifting section, so as to lift and rotatably contact with other CDs above the lowest CD while the shifting section is shifting the lowest CD out of the first and the second supporting wall.

14. The CD feeding mechanism as claimed in claim 1, wherein the base further includes a rib located below the CD inlet near the rightmost outer side thereof, and one side of the rib closer to the CD inlet being a rightward downward inclined beveled surface for rightward and downward guiding the CD through the moving passage to the CD outlet quickly.
